(19) United States
(12) Patent Application Publication
(10) Pub. No.: US 2023/0100118 A1
(43) Pub. Date: Mar. 30, 2023

(54) CARGO ASSIST SYSTEM

(71) Applicant: GM Global Technology Operations LLC, Detroit, MI (US)

(72) Inventors: Garrett P. Mitchell, Novi, MI (US); Nicholas Perry Thomas, Ortonville, MI (US); Kalvin Maurice Parker, Royal Oak, MI (US)

(21) Appl. No.: 17/486,041

(22) Filed: Sep. 27, 2021

(51) Int. Cl. B60P 7/04

(52) U.S. Cl. CPC B60P 7/04

(57) ABSTRACT

A vehicle seat includes a seat back, a seat base, and a cargo assist system including a cargo net configured to move between a deployed configuration in which the cargo net engages with the seat back and a retracted configuration which the cargo net is stored on a roller supported by the seat base.

### INTRODUCTION

The subject disclosure relates to vehicles and, more particularly, to a cargo assist system that may be incorporated into a passenger compartment of a vehicle.

Most vehicles include a rear seating area and a rear cargo zone. The rear cargo zone may be accessible internally of the vehicle, such as in a sport utility vehicle (SUV), or externally of the vehicle such as a trunk or a pickup truck bed. Often times, bags and/or other items may be placed on a rear seat as a convenience. For example, after shopping, bags full of groceries may be rested on the rear seat instead of being placed in a designated cargo area. Other times, papers, briefcases, and other objects may be rested on the rear seat for convenient access and/or removal.

Items resting on the rear seat are subject to movement when exposed to forces attributed to normal driving. Turning, stopping and other maneuvers may cause object to shift off the rear seat. In order to restrain movement, many consumers employ netting that may connect with vehicle head rests. The netting sits loose in the rear of the vehicle and may be connected as needed. Other consumers may position plastic crates on the rear seat to support bags and the like. Netting may get tangled, lost and can be difficult to set up. Plastic crates take up space and may be inconvenient when transporting passengers. Accordingly, it is desirable to provide a system that can be easily deployed to retain objects resting on a seat without the need to store or cause inconvenience to passengers.

### SUMMARY

In accordance with a non-limiting example, a vehicle seat includes a seat back, a seat base, and a cargo assist system including a cargo net configured to move between a deployed configuration in which the cargo net engages with the seat back and a retracted configuration which the cargo net is stored on a roller supported by the seat base.

In addition to one or more of the features described herein the roller comprises a spring biased roller configured to retract the cargo net from the deployed configuration to the retracted configuration.

In addition to one or more of the features described herein the seat base includes first surface configured to support a passenger and a second surface opposite the first surface, the cargo net being connected to the second surface.

In addition to one or more of the features described herein a cartridge member mounted to the second surface, the cartridge member including a spring biased roller, the cargo net being selectively deployable from the spring biased roller.

In addition to one or more of the features described herein a spring biased roller mounted between the first surface and the second surface of the seat base, the cargo net being selectively deployable from the spring biased roller.

In addition to one or more of the features described herein the seat base includes a forward surface that extends between the first side and the second side, the forward surface including an opening through which passes the cargo net.

In addition to one or more of the features described herein the cargo net includes a first side portion, a second side portion, an outer edge and a net portion connected to the first side portion, the second side portion and the outer edge.

In addition to one or more of the features described herein the seat back includes one or more hook elements and the cargo net includes one or more loops formed at the outer edge that are configured to receiving corresponding ones of the one or more hook elements to secure the cargo net in the deployed configuration.

In addition to one or more of the features described herein the outer edge is formed from a first material and the net portion is formed from a second material that is distinct from the first material.

In addition to one or more of the features described herein the cargo net includes one or more seat bite elements configured to be inserted into a seat bite between the seat back and the seat base.

In accordance with another non-limiting example, a cargo assist system configured to be mounted to a seat base includes a cargo net configured to move between a deployed configuration in which the cargo net engages with a seat back and a retracted configuration which the cargo net is stored on a roller supported by the seat base.

In addition to one or more of the features described herein the roller comprises a spring biased roller configured to retract the cargo net from the deployed configuration to the retracted configuration.

In addition to one or more of the features described herein the seat base includes first surface configured to support a passenger and a second surface opposite the first surface, the cargo net being connected to the second surface.

In addition to one or more of the features described herein a cartridge member mounted to the second surface, the cartridge member including a spring biased roller, the cargo net being selectively deployable from the spring biased roller.

In addition to one or more of the features described herein a spring biased roller mounted between the first surface and the second surface of the seat base, the cargo net being selectively deployable from the spring biased roller.

In addition to one or more of the features described herein the seat base includes a forward surface that extends between the first side and the second side, the forward surface including an opening through which passes the cargo net.

In addition to one or more of the features described herein the cargo net includes a first side portion, a second side portion, an outer edge and a net portion connected to the first side portion, the second side portion and the outer edge.

In addition to one or more of the features described herein the seat back includes one or more hook elements and the cargo net includes one or more loops formed at the outer edge that are configured to receiving corresponding ones of the one or more hook elements to secure the cargo net in the deployed configuration.

In addition to one or more of the features described herein the outer edge is formed from a first material and the net portion is formed from a second material that is distinct from the first material.

In addition to one or more of the features described herein the cargo net includes one or more seat bite elements configured to be inserted into a seat bite between the seat back and the seat base.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a vehicle including a cargo assist system, in accordance with a non-limiting example;

FIG. 2 depicts a rear seat of the vehicle shown in FIG. 1 depicting the cargo assist system, in accordance with a non-limiting example;

FIG. 3 is a cross-sectional, schematic view of as seat base of the rear seat of FIG. 2, depicting the cargo assist system in accordance with a non-limiting example;

FIG. 4 is a is a cross-sectional, schematic view of as seat base of the rear seat of FIG. 2, depicting the cargo assist system in accordance with another non-limiting example;

FIG. 5 depicts a cargo assist system in a first configuration, in accordance with a non-limiting example; and

FIG. 6 depicts the cargo assist system of FIG. 5 in a second configuration, in accordance with another non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

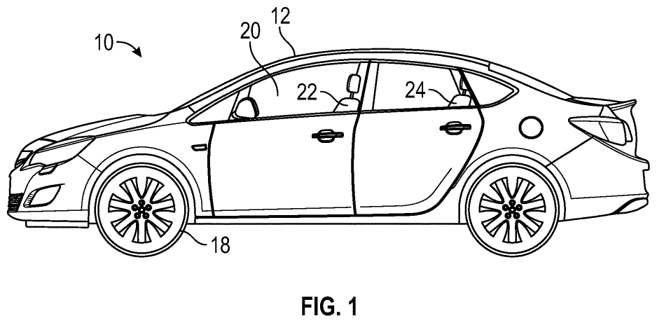

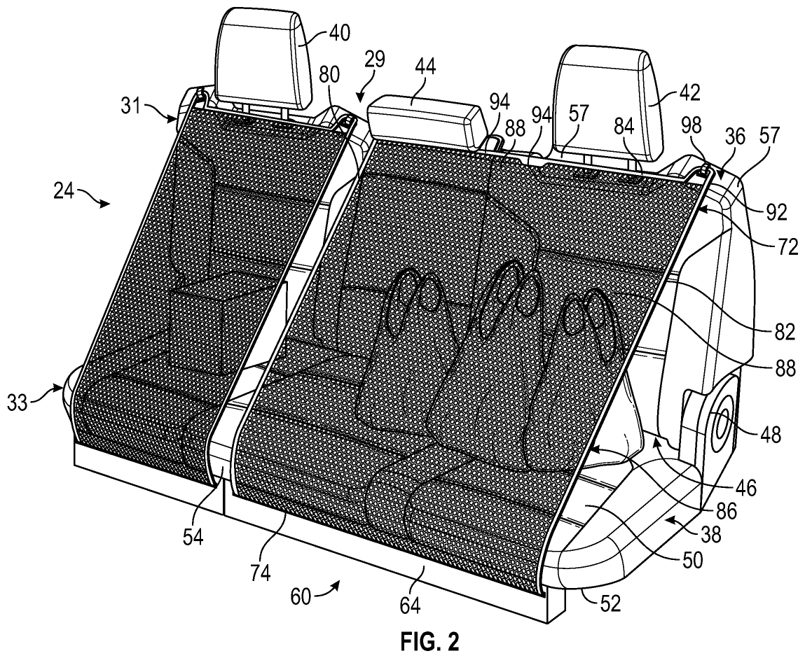

A vehicle, in accordance with a non-limiting example, is indicated generally at 10 in FIG. 1. Vehicle 10 includes a body 12 supported on a frame (not shown) and a plurality of wheels, one of which is indicated at 18. Body 12 includes a passenger compartment 20 that includes a front seat 22 and a rear seat 24. Referring to FIG. 2, rear seat 24 takes the form of a split bench seat 29 having a first seat back 31, a first seat base 33, a second seat back 36 arranged adjacent first seat back 31 and a second seat base 38 arranged adjacent first seat base 33. First seat back 31 may fold relative to first seat base 33 and second seat back 36 may fold relative to second seat base 38.

First seat back 31 includes a first headrest 40 and second seat back 36 includes a second headrest 42 and a third or center headrest 44. Second seat back 36 is separated from second seat base 38 by a seat bite 46. A hinge 48 is disposed at seat bite 46 to facilitate folding of second seat back 36. Second seat base 38 includes a first surface 50, a second, opposing surface 52, and a forward surface 54. First surface 50 defines a passenger seating surface. It should be understood that first seat base 33 includes similar structure.

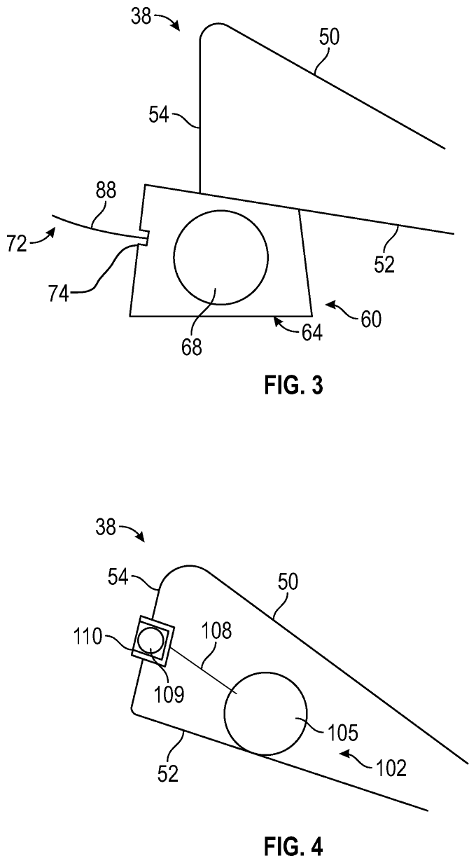

In accordance with a non-limiting example, a cargo assist system 60 is mounted to second surface 52 of second seat base 38 adjacent forward surface 54. Referring to FIG. 3, and with continued reference to FIG. 2, cargo assist system 60 includes a cartridge member 64 that contains roller which in accordance with a non-limiting example, is a spring biased roller 68. A cargo net 72 is spooled onto spring biased roller 68. Cargo net 72 passes through an opening 74 in cartridge member 64. Cargo net 72 may transition from a stored configuration to a deployed configuration as shown in FIG. 2. Moving from the stored position, in which a majority of cargo net 72 is contained within cartridge member 64, to the deployed configuration loads spring biased roller 68. In this manner, when released, spring biased roller 68 will automatically respool or retract cargo net 72 in a manner similar to that of a retractable window shade.

In a non-limiting example, cargo net 72 includes a first side portion 80, a second side portion 82, and an outer edge 84 that collectively form a frame 86 that surrounds a net portion 88. Net portion 88 may be made from a first material, such as fabric and frame 86 may be made from a second material, that is distinct from the first material, such as plastic. Of course, frame 86 and net portion 88 may also be made of the same material. In other non-limiting examples, first side portion 80, second side portion 82 and net portion 88 may be made from one material having a first stiffness and outer edge 84 may be made from a different material having a second stiffness that is distinct from the first stiffness. The different material may be, for example, plastic.

In a non-limiting example, outer edge 84 may include one or more loops 92. Loops 92 may be molded from plastic that forms outer edge 84 or may simply represent reinforced portions of net portion 88. Also, a handle 94 may be provided on outer edge 84. Handle 94 may serve as a stop, that prevents cargo net 72 from passing entirely through opening 74. Alternatively, outer edge 84 may define the stop. As depicted in FIG. 2, loops 92 are placed over hooks, such as indicated at 98, mounted to upper surface 57 of seat back 36 to secure cargo net 72 in the deployed configuration. In the deployed configuration, cargo net 72 prevents items resting on second seat base 38 from shifting forward and falling onto a floor (not shown) of passenger compartment 20.

FIG. 4 depicts a cargo assist system 102 integrated into, e.g., mounted within, second seat base 38 in accordance with another non-limiting example. Cargo assist system 102 includes a spring biased roller 105 supported between first surface 50 and second surface 52 of second seat base 38. A cargo net 108 having an outer edge 109 is supported in spring biased roller 105. Cargo net 108 passes through an opening 110 formed in forward surface 54 of second seat base 38 with outer edge 109 serving as a travel limiter. With this arrangement, under seat storage volume is unaffected by the presence of, for example a cartridge.

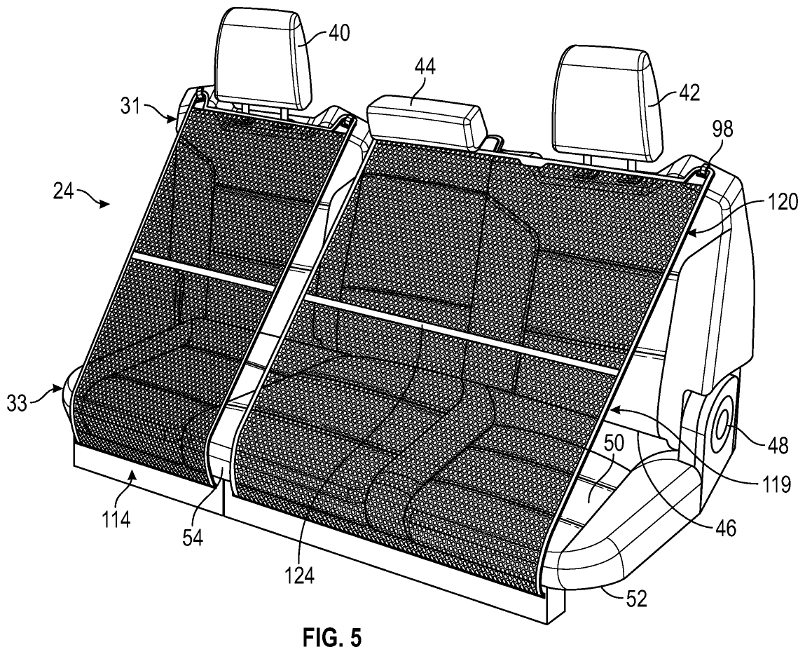

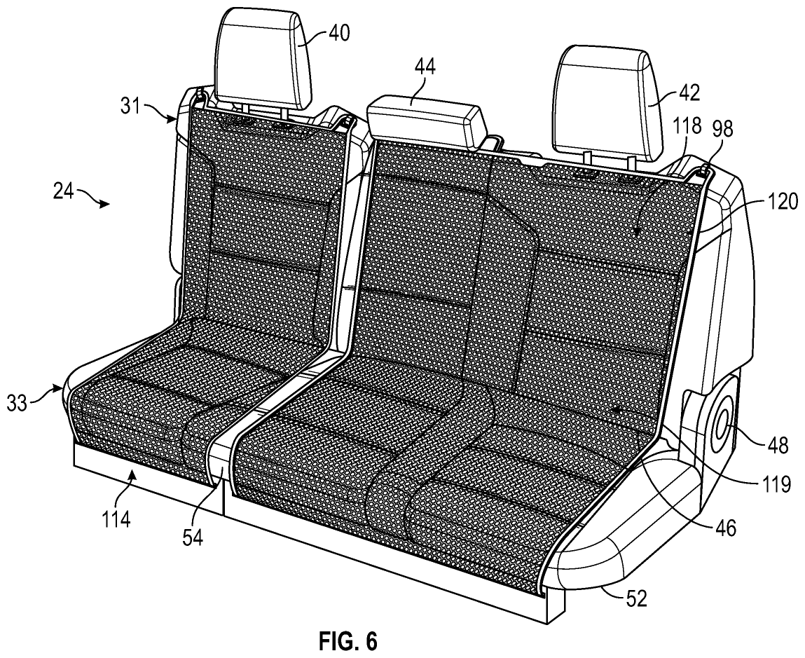

FIGS. 5 and 6 depict a cargo assist system 114 in accordance with another non-limiting example. Cargo assist system 114 includes a cargo net 119 that includes a frame 120 and a seat bite element 124 that may be inserted into seat bite 46 such that cargo net 118 forms a seat cover as shown in FIG. 6. At this point, it should be understood that while shown as a single seat bite element 124, multiple discrete seat bite elements may also be employed.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle seat comprising:
a seat back;
a seat base; and
a cargo assist system including a cargo net configured to move between a deployed configuration in which the cargo net engages with the seat back and a retracted configuration which the cargo net is stored on a roller supported by the seat base.

2. The vehicle seat according to claim 1, wherein the roller comprises a spring biased roller configured to retract the cargo net from the deployed configuration to the retracted configuration.

3. The vehicle seat according to claim 1, wherein the seat base includes a first surface configured to support a passenger and a second surface opposite the first surface, the cargo assist system being connected to the second surface.

4. The vehicle seat according to claim 3, further comprising a cartridge member mounted to the second surface, the cartridge member including a spring biased roller, the cargo net being selectively deployable from the spring biased roller.

5. The vehicle seat according to claim 3, further comprising a spring biased roller mounted between the first surface and the second surface of the seat base, the cargo net being selectively deployable from the spring biased roller.

6. The vehicle seat according to claim 5, wherein the seat base includes a forward surface that extends between the first surface and the second surface, the forward surface including an opening through which the cargo net passes.

7. The vehicle seat according to claim 1, wherein the cargo net includes a first side portion, a second side portion, an outer edge and a net portion connected to the first side portion, the second side portion and the outer edge.

8. The vehicle seat according to claim 7, wherein the seat back includes one or more hook elements and the cargo net includes one or more loops formed at the outer edge that are configured to receive corresponding ones of the one or more hook elements to secure the cargo net in the deployed configuration.

9. The vehicle seat according to claim 8, wherein the outer edge is formed from a first material and the net portion is formed from a second material that is distinct from the first material.

10. The vehicle seat according to claim 1, wherein the cargo net includes one or more seat bite elements configured to be inserted into a seat bite between the seat back and the seat base.

11. A cargo assist system configured to be mounted to a seat base comprising a cargo net configured to move between a deployed configuration in which the cargo net engages with a seat back and a retracted configuration which the cargo net is stored on a roller supported by the seat base.

12. The cargo assist system according to claim 11, wherein the roller comprises a spring biased roller configured to retract the cargo net from the deployed configuration to the retracted configuration.

13. The cargo assist system according to claim 11, wherein the seat base includes a first surface configured to support a passenger and a second surface opposite the first surface, the cargo net being connected to the second surface.

14. The cargo assist system according to claim 13, further comprising a cartridge member mounted to the second surface, the cartridge member including a spring biased roller, the cargo net being selectively deployable from the spring biased roller.

15. The cargo assist system according to claim 13, further comprising a spring biased roller mounted between the first surface and the second surface of the seat base, the cargo net being selectively deployable from the spring biased roller.

16. The cargo assist system according to claim 15, wherein the seat base includes a forward surface that extends between the first surface and the second surface, the forward surface including an opening through which the cargo net passes.

17. The cargo assist system according to claim 11, wherein the cargo net includes a first side portion, a second side portion, an outer edge and a net portion connected to the first side portion, the second side portion and the outer edge.

18. The cargo assist system according to claim 17, wherein the seat back includes one or more hook elements and the cargo net includes one or more loops formed at the outer edge that are configured to receive corresponding ones of the one or more hook elements to secure the cargo net in the deployed configuration.

19. The cargo assist system according to claim 18, wherein the outer edge is formed from a first material and the net portion is formed from a second material that is distinct from the first material.

20. The cargo assist system according to claim 11, wherein the cargo net includes one or more seat bite elements configured to be inserted into a seat bite between the seat back and the seat base.
